(19) United States
(12) Patent Application Publication
(10) Pub. No.: US 2023/0376945 A1
(43) Pub. Date: Nov. 23, 2023

(54) VIRTUALIZED TRANSACTION INSTRUMENTS USING PROCESSING ALIASES

(71) Applicant: American Express Travel Related Services Company, Inc., New York, NY (US)

(72) Inventors: Juan Figuera, New York, NY (US); Yinxuan Liu, New York, NY (US)

(21) Appl. No.: 17/750,982

(22) Filed: May 23, 2022

(51) Int. Cl. G06Q 20/38

(52) U.S. Cl. CPC G06Q 20/385

(57) ABSTRACT

Disclosed are various embodiments for virtualizing transaction instruments using processing aliases. A computing device can receive a first selection of a processing network from a plurality of available processing networks. Then, the computing device can receive a second selection of a backing source from a plurality of registered backing sources. Next, the computing device can generate a processing alias for the processing network. Subsequently, the computing device can store an association between the processing alias and the backing source.

### BACKGROUND

Users often wish to initiate transactions without disclosing the ultimate source of funds used for or backing the transaction. For example, users may not wish to provide transaction information to a merchant they do not completely trust. If the merchant is compromised or dishonest, the user's transaction information could be stolen and used to perform fraudulent transactions. As another example, a merchant may only be able to accept or process certain types of payment instruments, but an individual may wish to use another type of payment instrument. For example, a merchant may only accept credit or debit cards, but an individual may wish to pay with cryptocurrency.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

FIG. 6 is a flowchart illustrating one example of functionality implemented as portions of an application executed in a computing environment in the network environment of FIG. 1 according to various embodiments of the present disclosure.

FIG. 7A is a flowchart illustrating one example of functionality implemented as portions of an application executed in a computing environment in the network environment of FIG. 1 according to various embodiments of the present disclosure.

FIG. 7B is a flowchart illustrating one example of functionality implemented as portions of an application executed in a computing environment in the network environment of FIG. 1 according to various embodiments of the present disclosure.

### DETAILED DESCRIPTION

Disclosed are various approaches for generating virtualized transaction instruments in the form of arbitrary processing aliases for arbitrary processing networks. By using processing aliases for payment instruments, users are able to improve the security of transactions. For example, a user could generate a unique processing alias for individual transactions with third-parties. Should the security of one of the third-parties be compromised, only the processing alias is compromised.

Moreover, by generating arbitrary processing aliases for arbitrary processing networks, the coupling between the processing alias and the processing network is severed. For example, various embodiments of the present disclosure would allow an individual to generate an processing alias for a first processing network that is linked with a backing source associated with a separate processing network. As one example, an individual could generate an AMERICAN EXPRESS® processing alias that is linked to or funded by a credit card issued for another payment card interchange network, or vice versa. As another example, an individual could generate an AMERICAN EXPRESS processing alias (or a processing alias for another payment card interchange network) that is linked to or funded by another type of backing source (e.g., a cryptocurrency account on a cryptocurrency exchange, a demand deposit account with a bank, etc.).

As a result, the individual is able to complete transactions with a point-of-sale terminal that is not configured to operate with the backing source. For example, suppose that a point-of-sale (POS) terminal is unable to accept cryptocurrency coins or tokens (e.g., BITCOIN, ETHEREUM, various stable coins, etc.) as payment, but could accept AMERICAN EXPRESS or other payment interchange network branded transaction cards. An individual could use the various embodiments of the present disclosure for the practical purpose of paying with his or her cryptocurrency coins or tokens by generating an AMERICAN EXPRESS processing alias (or a processing alias for another payment card interchange network) that would be accepted by the POS terminal, but would be linked to the cryptocurrency account of the user as a backing source. As another example, supposed a POS terminal accepted transaction or payment cards branded by a first payment card interchange network, but would not accept AMERICAN EXPRESS branded transaction or payment cards. An individual could use the various embodiments of the present disclosure for the practical purpose of paying with his or her AMERICAN EXPRESS branded transaction card by generating a processing alias for another payment card interchange network that would be accepted by the POS terminal, but would be linked to the AMERICAN EXPRESS branded transaction card of the individual. In all of these examples, an individual is able to utilize the various embodiments of the present disclosure to make a payment using an arbitrary source of funds with any preexisting POS terminal, even if the POS terminal is not configured to process a payment using the source of funds.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

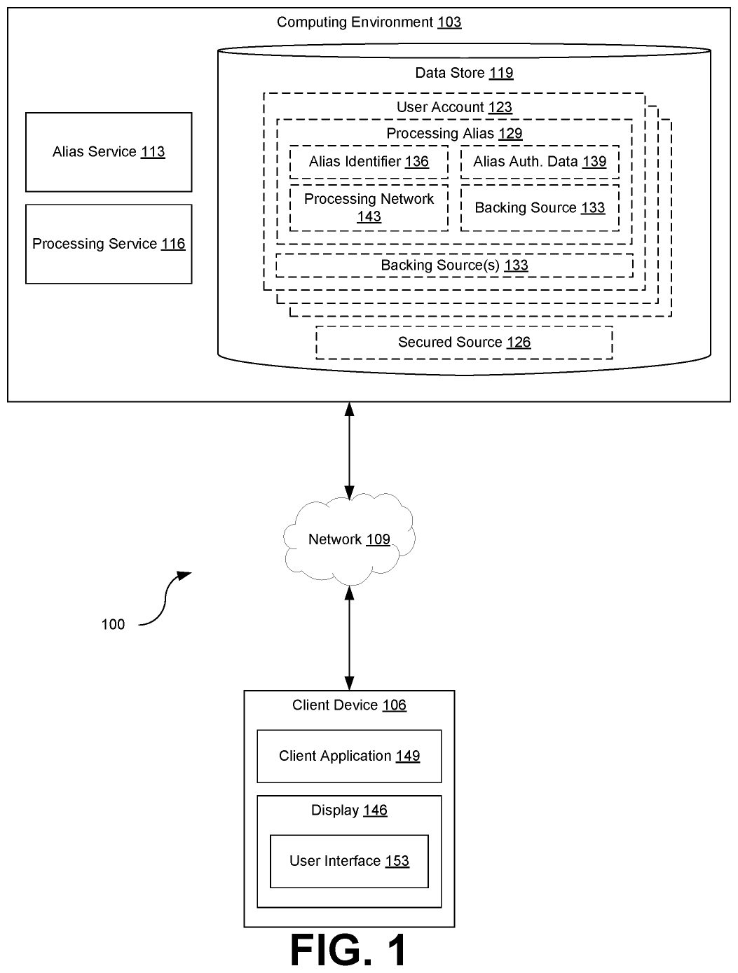

With reference to FIG. 1, shown is a network environment 100 according to various embodiments. The network environment 100 can include a computing environment 103, a client device 106. The computing environment 103 and the client device 106 can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include the alias service 113 and the processing service 116. The computing environment 103 can also be configured to execute or host other applications, services, processes, systems, engines, or functionality not discussed in detail herein.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include one or more user accounts 123, a secured source 126, and potentially other data.

The user accounts 123 can represent information of individuals who use the alias service 113 in the various embodiments of the present disclosure. Accordingly, each user of the alias service 113 could have a respective user account 123. The user account 123 could store information about the user, as well as other information associated with the alias service 113 or used by the alias service 113. This can include one or more processing aliases 129 created by the alias service 113 for the user, as well as one or more backing sources 133 registered by the user.

Each processing alias 129 can represent a virtual processing account or an alias for an existing processing account. As an example, a processing alias 129 could represent a virtual credit or debit card that is linked to or an alias for an existing credit or debit card. As another example, a processing alias 129 could represent a virtual credit or debit card that is linked to or an alias for an existing demand deposit account (e.g., a checking, savings, or money market account), a cryptocurrency account hosted by a cryptocurrency exchange, etc. Various information can be stored with or associated with a processing alias 129. This information can include an alias identifier 136, alias authentication data 139, the processing network 143, and/or the backing source 133 selected for the processing alias 129.

The alias identifier 136 represents a unique identifier that can uniquely identify a processing alias 129 with respect to other processing aliases 129. For example, the alias identifier 136 could be an ISO/IEC 7812 compliant payment card number composed of 8 to 19 digits.

Alias authentication data 139 can represent information that could be used to authenticate a processing alias 129. For example, if the processing alias 129 were a virtual credit or debit card account, then the alias authentication data 139 could include a randomly generated expiration date and a randomly generated card security code (CSC, also referred to as a “card validation code” (CVC), a card verification value (CVV), card identification (CID) number, etc.).

The processing network 143 can represent the payment rail or payment processing network that the processing alias 129 for which it is issued. For example, if the processing alias 129 were a virtual card created for the AMERICAN EXPRESS credit card network, the processing network 143 would indicate that the processing alias 129 was for a credit card payment rail using the AMERICAN EXPRESS network. Similarly, if the processing alias 129 were a virtual card created for another payment card interchange network, the processing network 143 would indicate that the processing alias 129 was for a credit card payment rail using the other payment card interchange network. As another example, if the processing alias were a virtual debit card created for a debit card payment rail, the processing network 143 could indicated that the processing alias 129 was for the debit card payment rail.

Each backing source 133 can represent an ultimate source of funds that can be used to fulfill payments using a processing alias 129. As previously mentioned, a user account 129 can have multiple backing sources 133 registered with it. A user-selected backing source 133 could be used as a source of funds for transactions made using the processing alias 129. Examples of backing sources 133 include existing credit or debit card accounts, demand deposit accounts, cryptocurrency accounts held on cryptocurrency exchanges, etc.

The secured source 126 can represent a temporary source of funds that can be used to fulfill payments made using a processing alias 129 in some implementations of the present disclosure. In these implementations, funds could be initially transferred from the backing source 133 to the secured source 126 in order to ensure or secure the funds for future payments. For example, if a demand deposit account were the backing source 133, the various embodiments of the present disclosure might transfer a predefined or specified amount of funds from the backing source 133 to the secured source 126 in order to ensure that there are sufficient funds for subsequent transactions made using the processing alias 129. Otherwise, fluctuations in the balance of the demand deposit account over time could result in situations where the demand deposit account had insufficient funds to cover transactions made using the processing alias 129. However, the secured source 126 could be used in a similar manner for other types of backing sources 133. For example, the available credit for a credit card account or the value of cryptocurrency in a cryptocurrency account held on a cryptocurrency exchange could also fluctuate over time, and funds could be similarly transferred from these backing sources to the secured source 126 to cover transactions made using the processing alias 129.

The alias service 113 can be executed to create and/or update processing aliases 129 requested by users or assigned to users, as discussed in more detail later. This can include obtaining the alias identifier 136 and alias authentication data 139 from an appropriate issuer for a processing network 143, as well as storing the associations between the alias identifier 136, alias authentication data 139, user selected processing network 143, and user selected or specified backing source 133.

The processing service 116 can be executed to process transactions using the processing alias 129. For example, when a user provides the alias identifier 136 and alias authentication data 139 to a POS terminal to initiate a transaction, the processing service 116 could receive the provides the alias identifier 136 and alias authentication data 139 from the POS terminal. The processing service 116 could then identify and authenticate the appropriate processing alias 129 and either authorize or reject the transaction. If the transaction is authorized, the processing service 116 could further cause funds or payment to be transferred from either the backing source 133 or the secured source 126 to the operator of the POS terminal, depending on the particular embodiment of the present disclosure.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 146, such as liquid crystal displays (LCDs), gas plasma-based flat panel displays, organic light emitting diode (OLED) displays, electrophoretic ink (“E-ink”) displays, projectors, or other types of display devices. In some instances, the display 146 can be a component of the client device 106 or can be connected to the client device 106 through a wired or wireless connection.

The client device 106 can be configured to execute various applications such as a client application 149 or other applications. The client application 149 can be executed in a client device 106 to access network content served up by the computing environment 103 or other servers, thereby rendering a user interface 153 on the display 146. To this end, the client application 149 can include a browser, a dedicated application, or other executable, and the user interface 153 can include a network page, an application screen, or other user mechanism for obtaining user input. The client device 106 can be configured to execute applications beyond the client application 149, such as email applications, social networking applications, word processors, spreadsheets, or other applications.

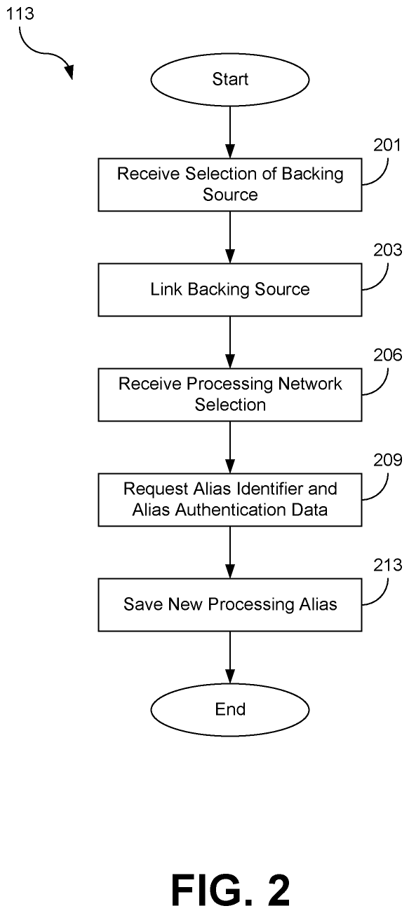

Next, a general description of the operation of the various components of the network environment 100 is provided. Although the following discussion describes the interactions of the various components of the network environment 100, the components of the network environment 100 can interact in other ways consistent with the present disclosure. Additional discussion of the operation of individual components of the network environment 100 is provided in the discussion of FIGS. 2-7.

To begin, a user of the client device 106 can connect to the alias service 113 using the client application 149 on his or her client device 106. Within the user interface 153, the user can request that the alias service 113 generate a new processing alias 129. In response, the alias service 113 can request that the user specify both a backing source 133 to use for funding the transactions made using the processing alias 129 to be generated. The alias service 113 can also request that the user specify a processing network 143 for the processing alias 129 that is to be generated.

The alias service 113 can then generate a processing alias 129. For example, the alias service 113 could send a request to an application programming interface (API) provided by an operator of the processing network 143. In response, the operator of the processing network 143 could return an alias identifier 136 and/or alias authentication data 139, which together could be used to perform a transaction using the processing network 143. The alias service 113 could then create the processing alias 129 and store the alias identifier 136, alias authentication data 139, processing network 143, and the backing source 133 as components of the processing alias 129.

In some implementations, the alias service 113 could further cause funds to be transferred from the backing source 133 to the secured source 126 once the processing alias 129 is created. A ledger entry could be created to track the funds held by the secured source 126 in these instances.

Subsequently, the user could provide his or her processing alias 129 (e.g., the alias identifier 136 and/or the alias authentication data 139) to a POS terminal (e.g., a physical POS terminal in a store, a virtual POS terminal used for electronic commerce applications or websites, etc.). The POS terminal could then send the alias identifier 136 and/or the alias authentication data 139 to the processing service 116 to authorize the transaction. In response, the processing service 116 could authorize the transaction and transfer funds from either the backing source 133 or the secured source 126 to the operator of the POS terminal according to the particular implementation.

Referring next to FIG. 2, shown is a flowchart that provides one example of the operation of a portion of the alias service 113. The flowchart of FIG. 2 provides merely an example of the many different types of functional arrangements that can be employed to implement the operation of the depicted portion of the alias service 113. As an alternative, the flowchart of FIG. 2 can be viewed as depicting an example of elements of a method implemented within the network environment 100.

Beginning with block 201, the alias service 113 can receive a selection of a backing source 133. For example, an individual could use the user interface 153 presented by the client application 149 on the display 146 of the client device 106 of the individual to select a backing source 133 from a plurality of backing sources 133 registered with the user account 123 of the individual.

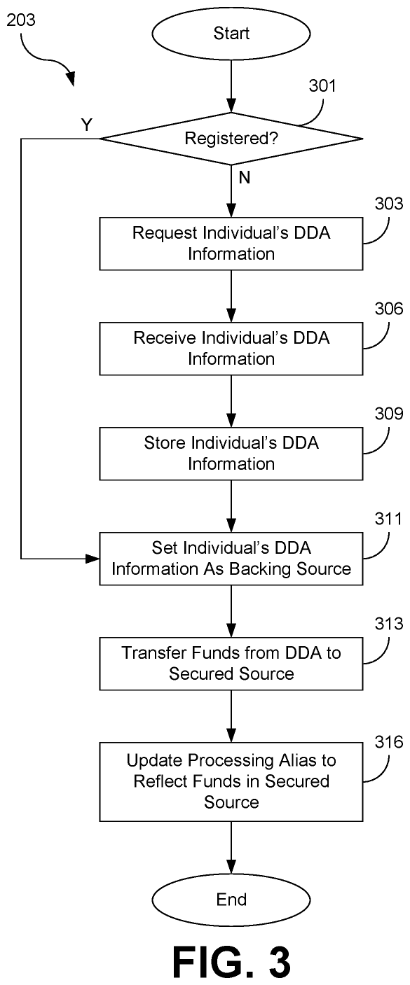

Then at block 203, the alias service 113 can link the backing source 133 to the processing alias 129 being created. Different approaches can be used to link different backing sources 133 to the processing alias 129. Examples of various approaches used for different types of backing sources 133 are illustrated in FIGS. 3-6.

Next, at block 206, the alias service 113 can receive a selection for a processing network 143 for the processing alias 129. For example, an individual could use the user interface 153 presented by the client application 149 on the display 146 of the client device 106 to select a processing network 143 from a list of supported processing networks 143. The client application 149 could then send the selection to the alias service 133.

Proceeding to block 209, the alias service 113 can invoke or call an application programming interface (API) function provided by an operator of the selected processing network 143, which was received at block 206, to obtain an alias identifier 136 and alias authentication data 139 for the processing alias 129. In some instances, processing networks 143 may provide publicly available API functions that, when called or invoked, return an alias identifier 136 and alias authentication data 139 that are compatible with their processing network 143. However, in other instances, the alias service 113 could have privileged, private, or exclusive access to an API provided by the operator of the processing network 143 which could be used to obtain an alias identifier 136 and alias authentication data 139 for the processing network 143.

Subsequently, at block 213, the alias service 113 can save the new processing alias 129 to the user account 123 of the individual. For example, the alias could create and save to the data store 119 a processing alias 129 that includes the alias identifier 136 and alias authentication data 139 requested at block 209, the processing network 143 selection received at block 206, and the backing source 133 received at block 201. Once the processing alias 129 is created and saved, the process could then end.

Referring next to FIG. 3, shown is a flowchart that provides one example of the operation of the alias service 113 linking a backing source 133 representing a demand deposit account (DDA) to a processing alias 129 as described in box 203 of FIG. 2. The flowchart of FIG. 3 provides merely an example of the many different types of functional arrangements that can be employed to implement the operation of the depicted portion of the alias service 113. As an alternative, the flowchart of FIG. 3 can be viewed as depicting an example of elements of a method implemented within the network environment 100.

Beginning with block 301, the alias service 113 can determine whether the requested or selected backing source 133 (e.g., a DDA) has been previously registered with the user account 123. If the selected backing source 133 has been previously registered with the user account 123, then the process can skip to block 313. However, if the selected backing source 133 has not been previously registered with the user account 123 (e.g., because the individual has not previously used the backing source 133), then the process can proceed to block 303 where the alias service 113 will obtain more information about the backing source 133.

Moving on to block 303, the alias service 113 could request DDA information for an individual, such as the bank account number for a checking or savings account of an individual and the American Banking Association (ABA) routing number identifying the bank where the DDA is held. In some instances, the request could be made directly to the user (e.g., the alias service 113 could send a request to the client application 149, which could prompt the user to enter this information within the user interface). In other instances, the request could be made to a data clearinghouse or data transfer network (e.g., PLAID®) that allows users to share their bank account information with authorized recipients.

Then, at block 306, the alias service 113 could receive the requested DDA information. As previously discussed, this could be received from the client application 149 or from a third-party data clearinghouse or data transfer network (e.g., PLAID®) in response to authorization by the individual to share the DDA information requested at block 303.

Next, at block 309, the alias service 113 can store the individual's DDA information. In order to protect the privacy of the individual, his or her DDA information could be stored in encrypted form.

Subsequently, at block 311 the alias service 113 can specify the individual's DDA information as the backing source 133 for the processing alias 129. This could include linking or associating the routing number and account number with processing alias 129. As a result, the DDA of the individual is linked to the processing alias 129 as a backing source 133.

In some implementations, the process can proceed to block 313, where the alias service 113 can transfer funds from the DDA backing source 133 to a secured source 126. This could be done, for example, to ensure that the processing alias 129 has sufficient funds to cover transactions as fluctuations in the account balance of the DDA could lead to situations where the DDA has insufficient funds to process the transaction. At block 313, the alias service 113 could also note or otherwise record that the secured source 126 contains funds from the backing source 133 to use for transactions.

Moving to block 316, the alias service 113 can then update the processing alias 129 to reflect that the funds of the backing source 133 have been transferred to the secured source 126. For example, the alias service 113 could record the secured source 126 as the backing source 133 for the processing alias 129 and note that amount of funds transferred at block 313 that would be available for use with the processing alias 129. Alternatively, the alias service 113 could record in the processing alias 129 that transactions made with the processing alias 129 should be funded from the secured source 126 and note that amount of funds transferred at block 313 that would be available for use with the processing alias 129. In this alternative, once the funds available in the secured source 126 drop below a predefined or previously specified level, additional funds could be transferred from the specified backing source 133 to the secured source 126 to use for future transactions.

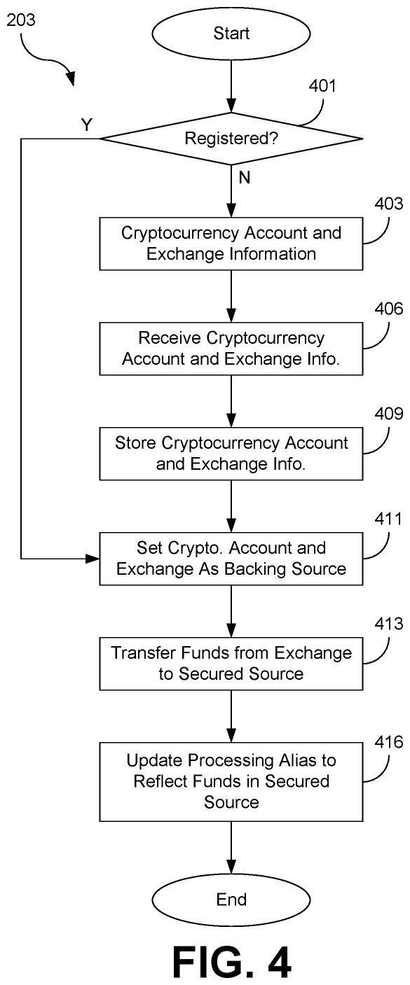

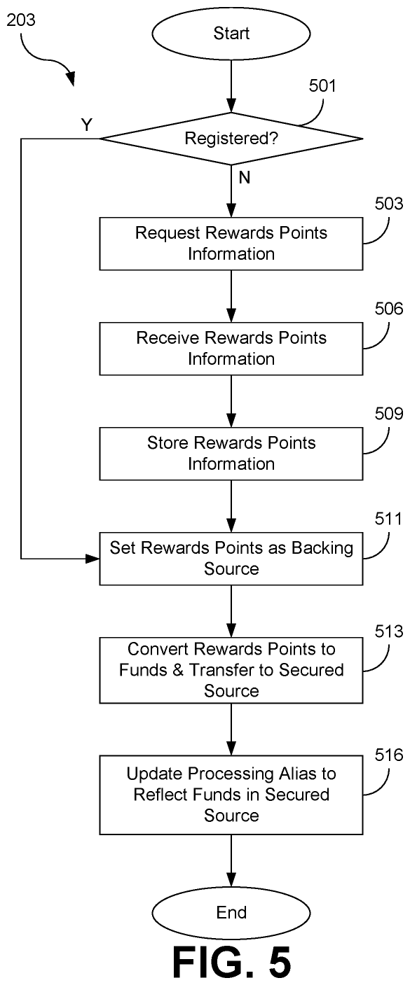

Referring next to FIG. 4, shown is a flowchart that provides one example of the operation of the alias service 113 linking a cryptocurrency account held with a cryptocurrency exchange as a backing source 133 to a processing alias 129 as described in box 203 of FIG. 2. The flowchart of FIG. 4 provides merely an example of the many different types of functional arrangements that can be employed to implement the operation of the depicted portion of the alias service 113. As an alternative, the flowchart of FIG. 4 can be viewed as depicting an example of elements of a method implemented within the network environment 100.

Beginning with block 401, the alias service 113 can determine whether the requested or selected backing source 133 (e.g., cryptocurrency held on account with a cryptocurrency exchange) has been previously registered with the user account 123. If the selected backing source 133 has been previously registered with the user account 123, then the process can skip to block 413. However, if the selected backing source 133 has not been previously registered with the user account 123 (e.g., because the individual has not previously used the backing source 133), then the process can proceed to block 403 where the alias service 113 will obtain more information about the backing source 133.

Moving on to block 403, the alias service 113 could request information identifying the cryptocurrency exchange and the cryptocurrency account of the individual that is held at the cryptocurrency exchange. The request could be made directly to the user. For example, the alias service 113 could send a request to the client application 149, which could prompt the user to enter this information within the user interface.

Then, at block 406, the alias service 113 could receive the requested cryptocurrency exchange and the cryptocurrency account information. This could include information such as the identity of the exchange, the username and password for the exchange, and/or the type of cryptocurrency to be used the backing source 133 (e.g., BITCOIN, ETHEREUM, etc.).

Next, at block 409, the alias service 113 can store the individual's cryptocurrency account information and the identity of the cryptocurrency exchange. In order to protect the privacy of the individual, the alias service 113 could authenticate with the cryptocurrency exchange using the username and password provided by the individual. In response, the alias service 113 could receive an authentication token that would allow the alias service 113 to authenticate with the cryptocurrency exchange on behalf of the user in the future.

Subsequently, at block 411 the alias service 113 can store the authentication token received at block 409 in conjunction with the identity of the cryptocurrency exchange as the backing source 133. As a result, the cryptocurrency account of the individual at the cryptocurrency exchange is linked to the processing alias 129 as a backing source 133.

In some implementations, the process can proceed to block 413, where the alias service 113 can transfer funds from the cryptocurrency account that serves as the backing source 133 to a secured source 126. This could be done, for example, to ensure that the processing alias 129 has sufficient funds to cover transactions as fluctuations in the cryptocurrency account balance (e.g., due to fluctuations in the value of the underlying cryptocurrency or due to fluctuations in the amount of cryptocurrency in the account) could lead to situations where the cryptocurrency account has insufficient reserves to process the transaction. Accordingly, the alias service 113 could send a request to the cryptocurrency exchange to liquidate an amount of cryptocurrency equal to a predefined or previously specified amount of fiat currency and transfer the proceeds to the secured source 126. In response, the cryptocurrency exchange could liquidate an appropriate amount of cryptocurrency and transfer the proceeds to the secured source 126. At block 413, the alias service 113 could also note or otherwise record that the secured source 126 contains funds from the backing source 133 to use for transactions.

Moving to block 416, the alias service 113 can then update the processing alias 129 to reflect that the funds of the backing source 133 have been transferred to the secured source 126. For example, the alias service 113 could record the secured source 126 as the backing source 133 for the processing alias 129 and note that amount of funds transferred at block 413 that would be available for use with the processing alias 129. Alternatively, the alias service 113 could record in the processing alias 129 that transactions made with the processing alias 129 should be funded from the secured source 126 and note that amount of funds transferred at block 413 that would be available for use with the processing alias 129. In this alternative, once the funds available in the secured source 126 drop below a predefined or previously specified level, additional funds could be transferred from the specified backing source 133 to the secured source 126 to use for future transactions.

Referring next to FIG. 5, shown is a flowchart that provides one example of the operation of the alias service 113 linking a backing source 133 to a processing alias 129 as described in box 203 of FIG. 2. The flowchart of FIG. 5 provides merely an example of the many different types of functional arrangements that can be employed to implement the operation of the depicted portion of the alias service 113. As an alternative, the flowchart of FIG. 5 can be viewed as depicting an example of elements of a method implemented within the network environment 100.

Beginning with block 501, the alias service 113 can determine whether the requested or selected backing source 133 (e.g., rewards points for a rewards point program) has been previously registered with the user account 123. If the selected backing source 133 has been previously registered with the user account 123, then the process can skip to block 513. However, if the selected backing source 133 has not been previously registered with the user account 123 (e.g., because the individual has not previously used the backing source 133), then the process can proceed to block 503 where the alias service 113 will obtain more information about the backing source 133.

Moving on to block 503, the alias service 113 could request information identifying the rewards points program and/or the rewards points provider (e.g., AMERICAN EXPRESS MEMBERSHIP REWARDS, etc.). The request could be made directly to the user. For example, the alias service 113 could send a request to the client application 149, which could prompt the user to enter this information within the user interface.

Then, at block 506, the alias service 113 could receive the requested rewards point program information. This could include information such as the identity of the rewards program, the username and password of the individual for accessing his or her rewards balance, etc.

Next, at block 509, the alias service 113 can store the individual's rewards program information. In order to protect the privacy of the individual, the alias service 113 could authenticate with the rewards program using the username and password provided by the individual. In response, the alias service 113 could receive an authentication token that would allow the alias service 113 to authenticate with the rewards program on behalf of the user in the future.

Subsequently, at block 511 the alias service 113 can store the authentication token received at block 509 in conjunction with the identity of the rewards program as the backing source 133. As a result, the rewards program is linked to the processing alias 129 as a backing source 133.

In some implementations, the process can proceed to block 513, where the alias service 113 can cause rewards points accumulated by the rewards program acting as the backing source 133 to be converted to cash and transferred to a secured source 126. This could be done, for example, to ensure that the processing alias 129 has sufficient funds to cover transactions as fluctuations in the rewards program account balance or redemption rates could lead to situations where the rewards program account has insufficient reserves to process the transaction. Accordingly, the alias service 113 could send a request to the rewards program to convert a sufficient number of rewards points to cash and to transfer the proceeds to the secured source 126, which is sometimes referred to by rewards programs as “Pay with Points.” In response, the rewards program could convert an appropriate amount of rewards points to cash and transfer the proceeds to the secured source 126. At block 513, the alias service 113 could also note or otherwise record that the secured source 126 contains funds from the backing source 133 to use for transactions.

Moving to block 516, the alias service 113 can then update the processing alias 129 to reflect that the funds of the backing source 133 have been transferred to the secured source 126. For example, the alias service 113 could record the secured source 126 as the backing source 133 for the processing alias 129 and note that amount of funds transferred at block 513 that would be available for use with the processing alias 129. Alternatively, the alias service 113 could record in the processing alias 129 that transactions made with the processing alias 129 should be funded from the secured source 126 and note that amount of funds transferred at block 513 that would be available for use with the processing alias 129. In this alternative, once the funds available in the secured source 126 drop below a predefined or previously specified level, additional funds could be transferred from the specified backing source 133 to the secured source 126 to use for future transactions.

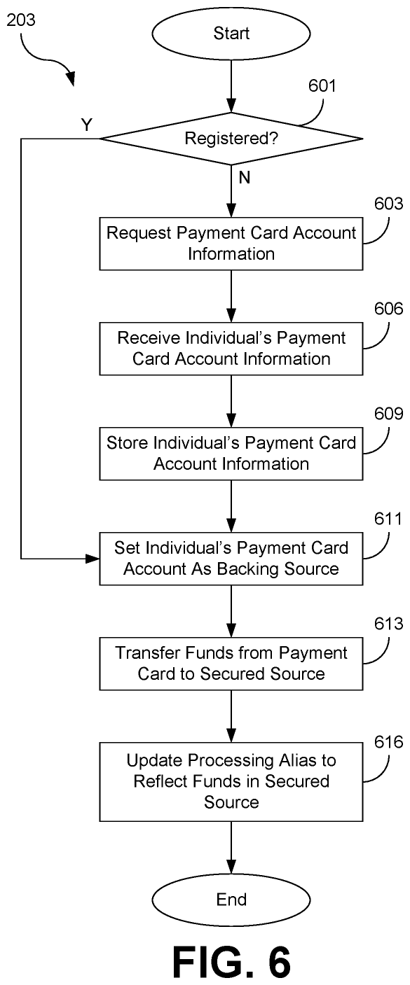

Referring next to FIG. 6, shown is a flowchart that provides one example of the operation of the alias service 113 linking a backing source 133 to a processing alias 129 as described in box 203 of FIG. 2. The flowchart of FIG. 6 provides merely an example of the many different types of functional arrangements that can be employed to implement the operation of the depicted portion of the alias service 113. As an alternative, the flowchart of FIG. 6 can be viewed as depicting an example of elements of a method implemented within the network environment 100.

Beginning with block 601, the alias service 113 can determine whether the requested or selected backing source 133 (e.g., a payment card such as a charge, credit or debit card) has been previously registered with the user account 123. If the selected backing source 133 has been previously registered with the user account 123, then the process can skip to block 613. However, if the selected backing source 133 has not been previously registered with the user account 123 (e.g., because the individual has not previously used the backing source 133), then the process can proceed to block 603 where the alias service 113 will obtain more information about the backing source 133.

Moving on to block 303, the alias service 113 could request payment card information for an individual, such as the charge, credit, or debit card account number for the individual and other authenticating information (e.g., card security code, expiration date, billing address, etc.). In some instances, the request could be made directly to the user (e.g., the alias service 113 could send a request to the client application 149, which could prompt the user to enter this information within the user interface).

Then, at block 606, the alias service 113 could receive the requested payment card information. As previously discussed, this could be received from the client application 149 in response to the request sent at block 603.

Next, at block 609, the alias service 113 can store the individual's payment card information. In order to protect the privacy of the individual, his or her payment card information could be stored in encrypted form.

Subsequently, at block 611 the alias service 113 can specify the individual's payment card information as the backing source 133 for the processing alias 129. This could include linking or associating the account number, expiration date, card security code, billing address, etc. with processing alias 129. As a result, the payment card account of the individual is linked to the processing alias 129 as a backing source 133.

In some implementations, the process can proceed to block 613, where the alias service 113 can transfer funds from the payment card acting as the backing source 133 to a secured source 126. For example, the alias service 113, acting in the role of a merchant, could process a payment with the payment card backing source 133 in order to receive sufficient funds. The transaction would therefore appear as purchase on any billing statement associated with the payment card account. This could be done, for example, to ensure that the processing alias 129 has sufficient funds to cover transactions as fluctuations in the account balance or available credit of the payment card account could lead to situations where the payment card account has insufficient funds or credit to process the transaction. At block 613, the alias service 113 could also note or otherwise record that the secured source 126 contains funds from the backing source 133 to use for transactions.

Moving to block 616, the alias service 113 can then update the processing alias 129 to reflect that the funds of the backing source 133 have been transferred to the secured source 126. For example, the alias service 113 could record the secured source 126 as the backing source 133 for the processing alias 129 and note that amount of funds transferred at block 613 that would be available for use with the processing alias 129. Alternatively, the alias service 113 could record in the processing alias 129 that transactions made with the processing alias 129 should be funded from the secured source 126 and note that amount of funds transferred at block 613 that would be available for use with the processing alias 129. In this alternative, once the funds available in the secured source 126 drop below a predefined or previously specified level, additional funds could be transferred from the specified backing source 133 to the secured source 126 to use for future transactions.

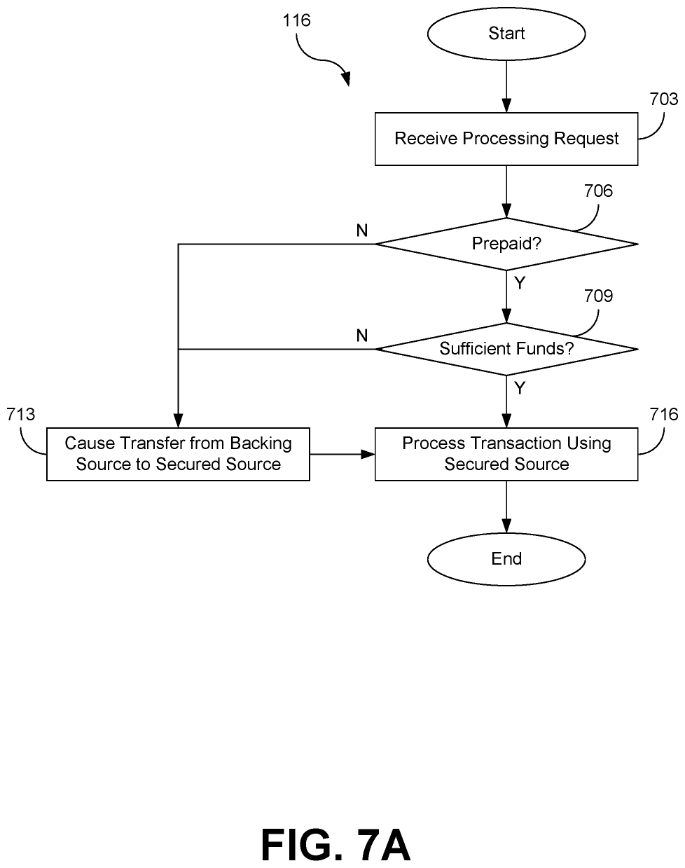

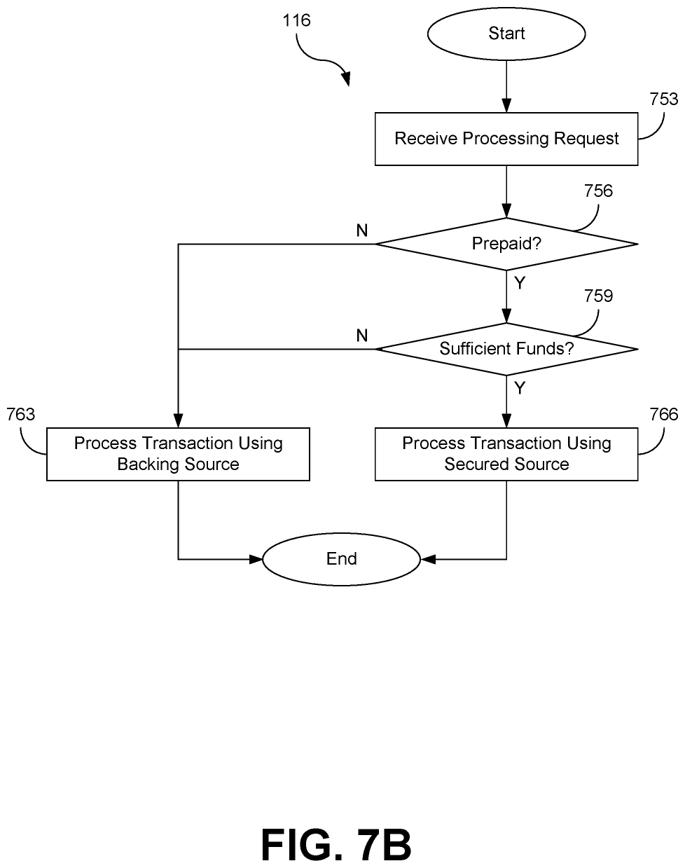

Referring next to FIG. 7A, shown is a flowchart that provides one example of the operation of a portion of the processing service 116. The flowchart of FIG. 7A provides merely an example of the many different types of functional arrangements that can be employed to implement the operation of the depicted portion of the processing service 116. As an alternative, the flowchart of FIG. 7A can be viewed as depicting an example of elements of a method implemented within the network environment 100.

Beginning with block 703, the processing service 116 can receive a processing request for a processing alias 129. This can include a request to authorize a transaction using the processing alias 129 and/or a request to send a backing amount of funds from the backing source 133 or secured source 126 to the originator of the processing request. For example, a merchant could have been presented with the processing alias 129 as a form of payment. The processing service 116 could then have received a processing request using the processing network 143 specified by the processing alias 129.

Then, at block 706, the processing service 116 can perform a first check to see if the processing alias 129 has already had funds prepaid to or otherwise deposited in advance with the secured source 126. This could have happened, for example, when the processing alias 129 was first created or at a later time (e.g., when the amount on account with the secured source 126 fell below a predefined or previously specified amount). If the processing alias 129 has not had funds prepaid to or otherwise deposited in advance with the secured source 126, then the process can proceed to block 713. However, if the processing alias has had had funds prepaid to or otherwise deposited in advance with the secured source 126, then the process can proceed to block 709.

Moving on to block 709, the processing service 116 can determine whether the processing alias 129 is associated with sufficient funds in the secured source 126 to cover the transaction. This could be done, for example, by evaluating the secure source 126 and/or any records or notes saved to the processing alias 129 record. If there are not sufficient funds stored in the secured source 126 to cover the processing request, the process can proceed to block 713. Otherwise, the process can proceed to block 716.

If the process proceeds to block 713, the processing service 116 cause a transfer of funds from the backing source 133 to the secured source 126. This could be performed using a variety of approaches, depending on the nature of the backing source 133, as previously described with respect to FIGS. 3-6. Once sufficient funds are transferred to the secured source 126, the process can proceed to block 716.

Subsequently, at block 716, the processing service 116 can authorize and process the transaction using the funds stored in the secured source 126. This can include sending the originator of the transaction a backing amount of funds from the secured source 126 sufficient to cover the processing amount specified in the processing request for the transaction. Once the processing request is completed, the process can end.

Referring next to FIG. 7B, shown is a flowchart that provides one example of the operation of a portion of the processing service 116. The flowchart of FIG. 7B provides merely an example of the many different types of functional arrangements that can be employed to implement the operation of the depicted portion of the processing service 116. As an alternative, the flowchart of FIG. 7B can be viewed as depicting an example of elements of a method implemented within the network environment 100.

Beginning with block 753, the processing service 116 can receive a processing request for a processing alias 129. This can include a request to authorize a transaction using the processing alias 129 and/or a request to send a backing amount of funds from the backing source 133 or secured source 126 to the originator of the processing request. For example, a merchant could have been presented with the processing alias 129 as a form of payment. The processing service 116 could then have received a processing request using the processing network 143 specified by the processing alias 129.

Then, at block 756, the processing service 116 can perform a first check to see if the processing alias 129 has already had funds prepaid to or otherwise deposited in advance with the secured source 126. This could have happened, for example, when the processing alias 129 was first created or at a later time (e.g., when the amount on account with the secured source 126 fell below a predefined or previously specified amount). If the processing alias 129 has not had funds prepaid to or otherwise deposited in advance with the secured source 126, then the process can proceed to block 763. However, if the processing alias has had had funds prepaid to or otherwise deposited in advance with the secured source 126, then the process can proceed to block 759.

Moving on to block 759, the processing service 116 can determine whether the processing alias 129 is associated with sufficient funds in the secured source 126 to cover the transaction. This could be done, for example, by evaluating the secure source 126 and/or any records or notes saved to the processing alias 129 record. If there are not sufficient funds stored in the secured source 126 to cover the processing request, the process can proceed to block 763. Otherwise, the process can proceed to block 766.

If the process proceeds to block 763, the processing service 116 cause a transfer of funds from the backing source 133 to the originator of the processing request. This could be performed using a variety of approaches, depending on the nature of the backing source 133. For example, if the backing source 133 were a demand deposit account, the processing service 116 could schedule an automated clearing house (ACH) or similar electronic transfer of funds equal to the processing amount of the processing request to the originator of the processing request. As another example, if the backing source 133 were a cryptocurrency account at a cryptocurrency exchange, the processing service 116 could send a request to the cryptocurrency exchange to liquidate sufficient cryptocurrency to cover the processing amount specified in the processing request and transfer the proceeds to the originator of the processing request. Once sufficient funds are transferred to the originator of the processing request from the backing source 133, the process can end.

However, if the process proceeds to block 766, the processing service 116 can authorize and process the transaction using the funds stored in the secured source 126. This can include sending the originator of the transaction a backing amount of funds from the secured source 126 sufficient to cover the processing amount specified in the processing request for the transaction. Once the processing request is completed, the process can end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a first selection of a processing network from a plurality of available processing networks;
receive a second selection of a backing source from a plurality of registered backing sources;
generate a processing alias for the processing network; and
store an association between the processing alias and the backing source.

2. The system of claim 1, wherein the machine-readable instructions further cause the computing device to at least:
transfer a backing amount from the backing source to a secured source linked to the processing alias;
subsequently receive a processing request through the processing network, the processing request comprising a processing amount; and
transfer, from the secured source, an amount equal to the processing amount to the originator of the processing request.

3. The system of claim 1, wherein the machine-readable instructions further cause the computing device to at least:
receive a processing request through the processing network, the processing request comprising a processing amount; and
in response to receipt of the processing request, transfer a backing amount equal to the processing amount from the backing source to an originator of the processing request.

4. The system of claim 3, wherein the machine-readable instructions that cause the computing device to transfer the backing amount equal to the processing amount from the backing source to the originator of the processing request further cause the computing device to at least:
transfer the backing amount to a secured source; and
transfer the backing amount from the secured source to the originator of the processing request.

5. The system of claim 1, wherein the machine-readable instructions further cause the computing device to at least:
receive information regarding a backing source from a client device; and
add the backing source to the plurality of registered backing sources.

6. The system of claim 1, wherein the machine-readable instructions that cause the computing device to generate the processing alias for the processing network, when executed, further cause the computing device to at least:
invoke an application programming interface (API) function provided by the processing network; and
receive an alias identifier in response to invocation of the API function.

7. The system of claim 1, wherein the processing network is a first processing network and the backing source operates on a second processing network separate from the first processing network.

8. A method, comprising:
receiving a first selection of a processing network from a plurality of available processing networks;
receiving a second selection of a backing source from a plurality of registered backing sources;
generating a processing alias for the processing network; and
storing an association between the processing alias and the backing source.

9. The method of claim 8, further comprising:
transferring a backing amount from the backing source to a secured source linked to the processing alias;
subsequently receiving a processing request through the processing network, the processing request comprising a processing amount; and
transferring, from the secured source, an amount equal to the processing amount to the originator of the processing request.

10. The method of claim 8, further comprising:
receiving a processing request through the processing network, the processing request comprising a processing amount; and
in response to receipt of the processing request, transferring a backing amount equal to the processing amount from the backing source to an originator of the processing request.

11. The method of claim 10, wherein transferring the backing amount equal to the processing amount from the backing source to the originator of the processing request further comprises:
transferring the backing amount to a secured source; and
transferring the backing amount from the secured source to the originator of the processing request.

12. The method of claim 8, further comprising:
receiving information regarding a backing source from a client device; and
adding the backing source to the plurality of registered backing sources.

13. The method of claim 8, wherein generating the processing alias for the processing network further comprises:
invoking an application programming interface (API) function provided by the processing network; and
receiving an alias identifier in response to invocation of the API function.

14. The method of claim 8, wherein the processing network is a first processing network and the backing source operates on a second processing network separate from the first processing network.

15. A non-transitory, computer-readable medium, comprising machine-readable instructions that, when executed by a processor of a computing device, cause the computing device to at least:
receive a first selection of a processing network from a plurality of available processing networks;
receive a second selection of a backing source from a plurality of registered backing sources;
generate a processing alias for the processing network; and
store an association between the processing alias and the backing source.

16. The non-transitory, computer-readable medium of claim 15, wherein the machine-readable instructions further cause the computing device to at least:
transfer a backing amount from the backing source to a secured source linked to the processing alias;
subsequently receive a processing request through the processing network, the processing request comprising a processing amount; and
transfer, from the secured source, an amount equal to the processing amount to the originator of the processing request.

17. The non-transitory, computer-readable medium of claim 15, wherein the machine-readable instructions further cause the computing device to at least:
receive a processing request through the processing network, the processing request comprising a processing amount; and
in response to receipt of the processing request, transfer a backing amount equal to the processing amount from the backing source to an originator of the processing request.

18. The non-transitory, computer-readable medium of claim 17, wherein the machine-readable instructions that cause the computing device to transfer the backing amount equal to the processing amount from the backing source to the originator of the processing request further cause the computing device to at least:
transfer the backing amount to a secured source; and
transfer the backing amount from the secured source to the originator of the processing request.

19. The non-transitory, computer-readable medium of claim 15, wherein the machine-readable instructions further cause the computing device to at least:
receive information regarding a backing source from a client device; and
add the backing source to the plurality of registered backing sources.

20. The non-transitory, computer-readable medium of claim 15, wherein the machine-readable instructions that cause the computing device to generate the processing alias for the processing network, when executed, further cause the computing device to at least:
invoke an application programming interface (API) function provided by the processing network; and
receive an alias identifier in response to invocation of the API function.
